(19) United States
(12) Patent Application Publication
(10) Pub. No.: US 2004/0210829 A1
(43) Pub. Date: Oct. 21, 2004

(54) Method of managing print requests of hypertext electronic documents

(75) Inventors: Mauro Cristofari, Roma (IT); Michele Crudele, Isernia (IT)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/731,908

(22) Filed: Dec. 10, 2003

(30) Foreign Application Priority Data
Apr. 18, 2003 (EP) 03368033.1

(51) Int. Cl. G06F 17/00

(52) U.S. Cl. 715/501.1

(57) ABSTRACT

In a data processing apparatus executing a hypertext-document browsing software application, a method of managing requests to print a selected hypertext electronic document, for example the hypertext document currently displayed, comprises, under the control of the browsing software, the acts of creating an output electronic document and incorporating therein an information content of the selected hypertext electronic document, and automatically inspecting the selected hypertext electronic document for detecting the presence of hypertext links to respective linked hypertext electronic documents. For each hypertext link detected in the selected hypertext electronic document, the respective linked hypertext document is automatically accessed without having the user personally activating the corresponding hypertext link; an indication of an information content of the linked hypertext document is also automatically extracted therefrom, and provided to the user. Conditioned by a selection of the user, at least said indication of the information content of the linked hypertext electronic document is included into the output electronic document.

### TECHNICAL FIELD

The present invention generally relates to the field of electronic data processing systems; in particular, the invention relates to the managing of hypertext electronic documents, such as electronic documents in hypertext markup language of the type supported by the World Wide Web. Specifically, the invention concerns the operation of printing (either to a material support, such as paper, or to an electronic file) of hypertext documents.

### BACKGROUND OF THE INVENTION

During the last years, computer networking has experienced an impressive growth. Probably the most widely known example of computer network is the Internet, a massive network of networks that connects millions of computers together globally, and in which any computer can in principle communicate with any other computer.

Information travels over the Internet via a variety of languages, known as protocols, such as the Simple Message Transfer Protocol (SMTP), used for electronic mail messaging, the File Transfer Protocol, used for transferring files, and the HyperText Transfer Protocol (HTTP). The HTTP is the protocol used by a system of Internet servers, globally referred to as the World Wide Web (WWW) or, briefly, the Web, for sharing information with each other. The servers of the WWW support electronic documents written in the HyperText Markup Language (HTML). A peculiarity of HTML is that this language allows for the creation of electronic documents including hypertext links to other electronic documents. Electronic documents formatted in HTML are commonly referred to as Web pages.

Dedicated software applications, generally referred to as browsers, have been developed and commercialized for enabling a computer user to move through (“surf”, in jargon) the Web; in particular, the browsers allows accessing Web pages spread over the Web, downloading and displaying them on the display device of the computer of the user. Nowadays, the most known Web browsers are probably Microsoft Internet Explorer and Netscape Navigator.

A generic Web page frequently contains, in addition to text and, possibly, graphics and/or audio and/or video content, several hypertext links to other Web pages; such links may be displayed as buttons or _{C}hot spots_{C} (e.g., words or phrases that highlights when the pointer icon of the user pointing device passes thereover) and, by clicking on the link, the user can access the linked documents.

Starting from an initial Web page, accessed for example by inputting the respective address, the user can thus jump to a linked Web page; the linked Web page may in turn contain hypertext links to additional linked Web pages, which the user can access activating the respective links, and so on.

When surfing the Web, several levels of Web page nesting can be and normally are encountered. For example, a Web page dealing with a given subject may incorporate a hypertext link to another Web page including a drawing figure, possibly with a description of the drawing, or the linked Web page may expand the discussion of an aspect of the subject dealt with only briefly in the main Web page.

More generally, whenever the computer user, for example after having conducted a search using one or more of the known Web search engines, finds out a Web page considered interesting, he/she may have to visit several Web pages linked thereto directly or indirectly in order to appreciate the full informative content, jumping to-and-fro between the main Web page and the linked Web pages.

In other words, in order to obtain exhaustive information on a searched subject, the user normally needs to manually move through a tree of linked hypertext documents and, whenever a displayed hypertext document is deemed interesting, print it; the documents are thus printed one by one, as separate documents.

This process is tedious, confusing and sometime even discouraging, and often causes the user to forget visiting and printing interesting Web pages.

Additionally, the final product, i.e. the printout of the visited Web pages, is scarce in quality and difficult to be read, because the different Web pages are printed in sequence and as separate documents.

Some of the commercially available Web browsers, e.g. Microsoft Internet Explorer, offer to the user the possibility of printing the currently-displayed Web page together with all the Web pages directly linked thereto by hypertext links included in the Web page currently displayed. In this way, the user may save time, not having to individually access and print all the Web pages directly linked to the displayed Web page.

However, also in this case the different Web pages are printed as separate documents. Moreover, since the process is not selective, by exploiting this functionality it may easily happen that a lot of non-interesting Web pages are printed; this is undesirable under many respects, waste of paper being only the most visible one. In addition to this, the frequent case of nested hypertext links is not covered by this functionality: only the Web pages directly linked to the currently-displayed Web page are printed; additional Web pages possibly linked directly or indirectly to the Web pages that are in turn directly linked to the currently-displayed Web page are not printed: if the user wishes to print these additional Web pages, he/she has to access each of the Web pages directly linked to the currently-displayed Web page, and repeat the process, or jump to each of the additional Web pages and print it individually. In other words, the _{C}print all linked documents_{C} functionally featured by some of the commercially-available Web browsers is only effective when a single level of Web page nesting exists, and the majority of the Web pages directly linked to the currently-displayed Web page are interesting to the user.

### SUMMARY OF THE INVENTION

In view of the state of the art outlined above, it has been an object of the present invention to improve the efficiency of known Web browsers.

In particular, it has been an object of the present invention to facilitate the task of printing groups of linked Web pages.

This and other objects have been attained by means of a method of managing requests to print a hypertext electronic document as set forth in the appended claims.

In brief, when the user wishes to print a selected hypertext electronic document (either onto a material support, such as paper, by means of a printer, or to an electronic file), a new output electronic document is created, and the information content of the selected hypertext document is incorporated in the output document.

Additionally, the selected hypertext document is automatically inspected for detecting the presence of hypertext links to linked hypertext electronic documents.

For each hypertext link detected, the respective linked hypertext document is automatically accessed: the user is not required to personally activate the corresponding hypertext link. The user is then provided with an indication of an information content of the respective linked hypertext electronic document, automatically extracted from the linked hypertext electronic document. For each hypertext link, conditioned on the selection made by the user, at least the indication of the information content of the respective linked hypertext electronic document is included in the output electronic document, preferably in a location corresponding to that of the respective hypertext link in the selected hypertext electronic document.

### BRIEF DESCRIPTION OF THE DRAWINGS

The features and advantages of the present invention will be made apparent by the following detailed description of an embodiment thereof, provided merely by way of non-limitative example, which will be made in conjunction with the attached drawing sheets, wherein:

FIG. 1 is a schematic view of a computer network supporting the exchange of hypertext documents, such as the World Wide Web based on the Internet;

FIG. 2 schematically shows, in terms of functional blocks, the main components of a computer of a generic user connected to the network;

FIG. 3 pictorially shows a partial content of a working memory of the computer of the generic user, while running a hypertext document browsing software, for example a Web browser, according to an embodiment of the present invention;

FIG. 4 pictorially shows an exemplary group of hypertext documents, particularly Web pages, linked to each other through hypertext links;

FIG. 5 pictorially shows a menu page that is displayed to the generic computer user when he/she wishes to print a currently-displayed hypertext document, for example a starting Web page of the group of Web pages shown in FIG. 4, in one embodiment of the present invention;

FIG. 6 is a schematic flowchart illustrating the operation of the hypertext document browsing software in a phase of building up a hierarchic-tree representation of a group of linked hypertext documents, for example the group of Web pages of FIG. 4, in one embodiment of the present invention;

FIG. 7 schematically shows a table that is created by the hypertext document browsing software during the phase of building up the hierarchical-tree representation of the group of linked hypertext documents;

FIG. 8 pictorially shows an exemplary hierarchic-tree representation generated by the hypertext document browsing software that is displayed to the user, in one embodiment of the present invention; and

FIGS. 9A and 9B are a schematic flowchart illustrating the operation of the hypertext document browsing software in a phase of creating a unitary output document, for example intended to be fed to a printer, out of the group of linked hypertext documents.

### DETAILED DESCRIPTION OF THE PREFERRED EMBODIMENT

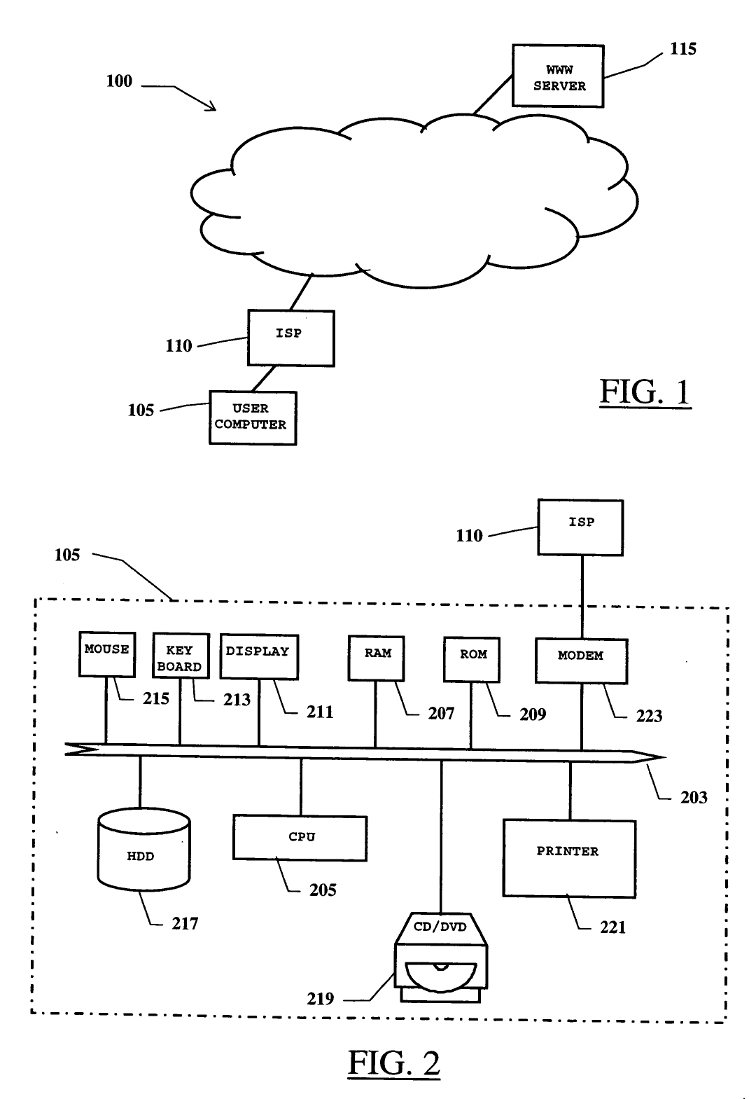

With reference to the drawings, in FIG. 1 a computer network 100 supporting the exchange of hypertext electronic documents, particularly HTML documents, is schematically shown. In the following, it will be assumed that the computer network 100 is the Internet and, more specifically, reference will be made to the World Wide Web; however, it is observed that this is not to be intended as a limitation of the present invention, which, as will be understood, is readily applicable to the browsing of generic electronic documents formatted according to a language that, similarly to HTML, supports embedded links to other electronic documents.

A computer 105 of a generic user is connected to the network 100, for example through a computer 110 of a network connectivity service provider, particularly an Internet Service Provider (ISP) computer; in particular, the computer 105 of the user may be connected to the ISP computer 110 through a MODEM and a dial-up connection, e.g. via the Public-Switched Telephone Network (PSTN), or through an XDSL connection, a cable MODEM, a fiber-optic link, a satellite connection and the like. The specific type of connection between the computer 105 of the generic user and the computer 110 of the ISP is not relevant to the present invention.

More generally, the computer 105 of the generic user may be part of a local network of computers, such as a Local Area Network (LAN) connecting together different computers of a company, an enterprise, a firm, a small-office environment, e.g. an Ethernet-based network, and the computer 105 of the generic user may be connected to the ISP computer 110 through a router.

Also shown in FIG. 1 is a further computer 115, connected to the network 100; for the purposes of the present description, it is assumed that the computer 115 is an Internet server computer part of the World Wide Web (i.e., a WWW server), supporting hypertext documents; in particular, and by of example only, it will be assumed that the computer 115 hosts a generic group of Web pages linked together by hypertext links (briefly, hyperlinks); such a group of Web pages makes up what is commonly referred to as a Web site, assumed to be visited by the user of the computer 105.

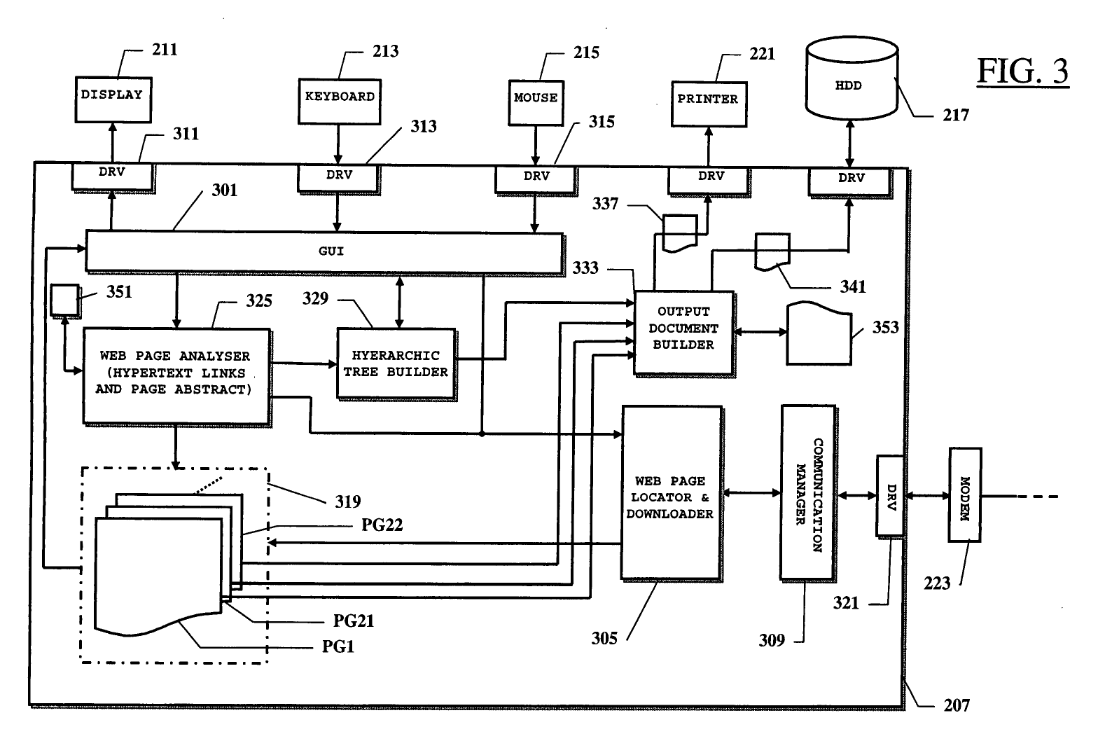

As schematically shown in FIG. 2, the computer 105 comprises several functional units connected in parallel to a data communication bus 203, for example of the PCI type. In particular, a Central Processing Unit (CPU) 205, typically comprising a microprocessor, controls the operation of the computer 105, a working memory 207, typically a Random Access Memory (RAM), is directly exploited by the CPU 205 for the execution of programs and for temporary storage of data, and a Read Only Memory (ROM) 209 stores a basic program for the bootstrap of the computer 105. The computer 105 comprises several peripheral units, connected to the bus 203 by means of respective interfaces. Particularly, peripheral units that allow an easy and friendly interaction with a human user are provided, such as a display device 211 (for example a CRT, an LCD or a plasma monitor), a keyboard 213 and a pointing device 215 (for example a mouse or a touchpad). The computer 105 also includes peripheral units for local mass-storage of programs and data (e.g., operating system, application programs, user files), such as a magnetic Hard-Disk Driver (HDD) 217, driving magnetic hard disks, and a CD-ROM/DVD driver 219, for reading/writing CD-ROMs/DVDs. Other peripheral units may be present, such as a floppy-disk driver for reading/writing floppy disks, a memory card reader for reading/writing memory cards and the like. A printer 221, for example an ink-jet printer or a laser printer or the like, may additionally be connected to the computer 105, for enabling the user printing documents onto a material (paper) support in user-readable form. The computer 105 is further equipped with a MODEM 223, for the connection to the Internet service provider computer 110; alternatively, where the computer 105 is part of a local computer network, e.g. a LAN, a Network Interface Adapter (NIA) card is provided, for the connection to the local computer network.

It is observed that, in the exemplary case of the computer 105 being part of a local network, the printer 221, instead of being a local printer directly connected to the computer 105, may be a network printer, shared by different computers of the local network, or a shared printer connected directly to another computer of the network but configured for a shared use.

Any other computer in the computer network 100, for example the computer 110 and the computer 115, has a structure generally similar to the one depicted in FIG. 2, possibly properly scaled, depending on the machine computing performance.

In order to access the World Wide Web, that is, to locate desired Web pages within the World Wide Web and display them in human-readable form on the display device 211, the user of the computer 105 exploits a specifically-designed software application, commonly referred to as a browsing software or Web browser. Commercially-available Web browsers, such as Microsoft Internet Explorer and Netscape Navigator, are capable of displaying Web pages containing text, graphics and even additional multimedia content, such as video and sound. The Web browser, assumed to have been properly installed on the computer 105, is launched by the user.

FIG. 3 schematically shows the partial content of the working memory 207 of the computer 105 while executing a Web browser according to an embodiment of the present invention. A graphical user interface (GUI) software module 301 allows a friendly interaction of the computer user with the browsing software, through the display device 211 and the input devices 213 and 215; in particular, hardware-dependent software drivers 311, 313 and 315 are exploited by the GUI 301 for interacting with the peripheral devices 211, 213 and 215, respectively.

When the user wishes to access a given Web page in the World Wide Web, he/she has to provide an address of the Web page to the browsing software; such a Web page address, also referred to as Uniform Resource Locator (URL), univocally identifies that Web page within the World Wide Web. For example, using the keyboard, the user inputs the Web page address in a specifically-designed fill-in area (generally labeled _{C}address_{C}, or _{C}URL_{C}) of a window that is displayed on the display device 211 when the browsing software is running. Alternatively, the user may retrieve the Web page address from a user-created list of preferred Web page addresses, managed by a specific utility module of the browsing software (not shown in FIG. 3), that is saved on the computer hard disk 217. Another possibility for the user is to access a desired Web page getting to it through a hyperlink contained in another Web page. This is typically what happens when the user, wishing to get information on a given subject, performs a keyword search exploiting one or more of the known Web search engines; the search engine provides, as a result, a list of potentially-interesting Web page addresses, with a brief description of the page content and hyperlinks to each page. By activating the desired hyperlink(s), the user can access the corresponding Web page(s).

In any case, the GUI 301 provides the selected Web page address to a Web page locator and downloader software module (in the following, for brevity, Web page locator) 305. The Web page locator 305 invokes a communication manager software module 309, managing the low-level (e.g., protocol level) details of the communication of the computer 105 with the ISP computer 110, for example by means of the MODEM 223, driven by a suitable software driver 321.

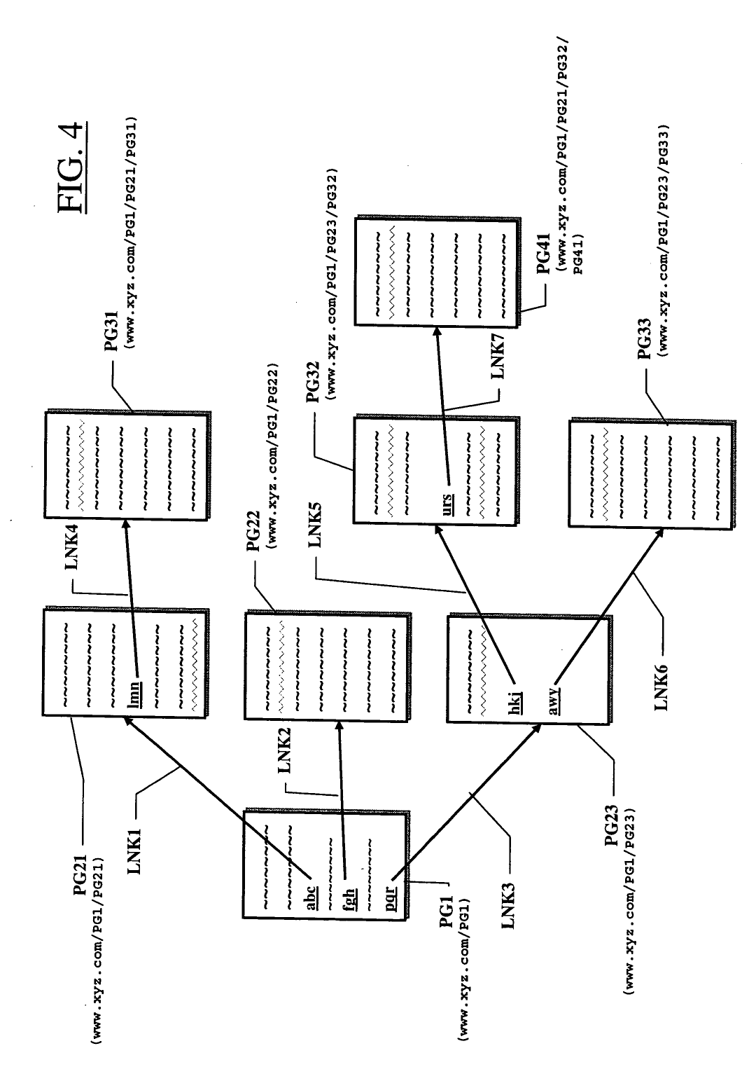

Let it be assumed that the user of the computer 105 provides to the browsing software running thereon the address of a Web page residing on the computer 115, for example the address www.xyz.com/PG1 identifying the Web page PG1 in the exemplary group of Web pages depicted in FIG. 4. Through the specified address, the computer 115 and the Web page PG1 are identified within the World Wide Web; once the Web page PG1 is identified, the Web page locator 305 downloads the Web page PG1 into the working memory 207 of the computer 105, for example saving it in a cache area 319 wherein a the most recently downloaded Web pages are stored. Through the GUI 301, the downloaded Web page PG1 can thus be displayed to the user on the display device 211.

The user can thus look at the displayed Web page and appreciate the information content thereof, reading the text, viewing the graphic content and the like.

Exploiting the functionalities of conventional Web browsers, the user also has the possibility of printing the displayed Web page.

Let it be assumed that the accessed and downloaded Web page PG1 contains one or more hypertext links to other Web pages, residing either on the same computer 115 or on different computers; such hypertext links may be displayed as buttons or _{C}hot spots_{C} (e.g., words or phrases that highlights when the movable icon of the pointing device passes thereover) and, by clicking on the links, the user can access, download and display the selected linked Web pages on the display device 211 of his/her computer 105.

For example, referring again to FIG. 4, let it be supposed that the accessed Web page PG1 is an initial page (for example, a home page) of a generic Web site, and that the Web page PG1 contains hypertext links LNK1, LNK2 and LNK3 to other, first-level Web sub-pages PG21, PG22 and PG23, each one identified by a respective address www.xyz.com/PG1/PG21, www.xyz.com/PG1/PG22 and www.xyz.com/PG1/PG23. Let it also be assumed that, in turn, the Web sub-page PG21 contains a hypertext link LNK4 to another, second-level Web sub-page PG31, identified by the address www.xyz.com/PG1/PG21/PG31, and that the Web sub-page PG23 includes hypertext links LNK5 and LNK6 to two other second-level Web sub-pages PG32 and PG33, respectively, identified by respective addresses www.xyz.com/PG1/PG23/PG32 and www.xyz.com/PG1/PG23/PG33. Finally, the Web sub-page PG32 is supposed to include a link LNK7 to a third-level Web sub-page PG41, identified by the address www.xyz.com/PG1/PG23/PG32/PG41.

Using a conventional Web browser, starting from the initial Web page PG1, the user should visit all of the linked Web pages PG21 to PG41, download, display and look at each of them and, if desired, print each of these pages separately. Alternatively, provided that the Web browser supports such a functionality, the user would have the possibility of printing, as separate documents, the currently-displayed Web page PG1 together with all the Web pages PG21, PG22, PG23 directly linked thereto by the hypertext links LNK1, LNK2 and LNK4 included in the page PG1 displayed. The drawbacks of these conventional print functionalities of the known Web browsers have already been discussed in the introductory part of the present description.

It is pointed out that, for the purposes of the present invention, the term printing is to be construed widely, encompassing both printing onto a material support, such as paper, by means of a printer, and printing to an electronic file. Generally speaking, printing should be construed to mean creating an output document, either printable onto a material support in human-readable form, or adapted to save in an electronic file.

According to an embodiment of the present invention, when the user, after having accessed a Web page such as the exemplary Web page PG1, wishes to print it (either on a material support, such as paper, or to an electronic file), he/she is offered an additional print functionality compared to the conventional print functions offered by the known Web browsers.

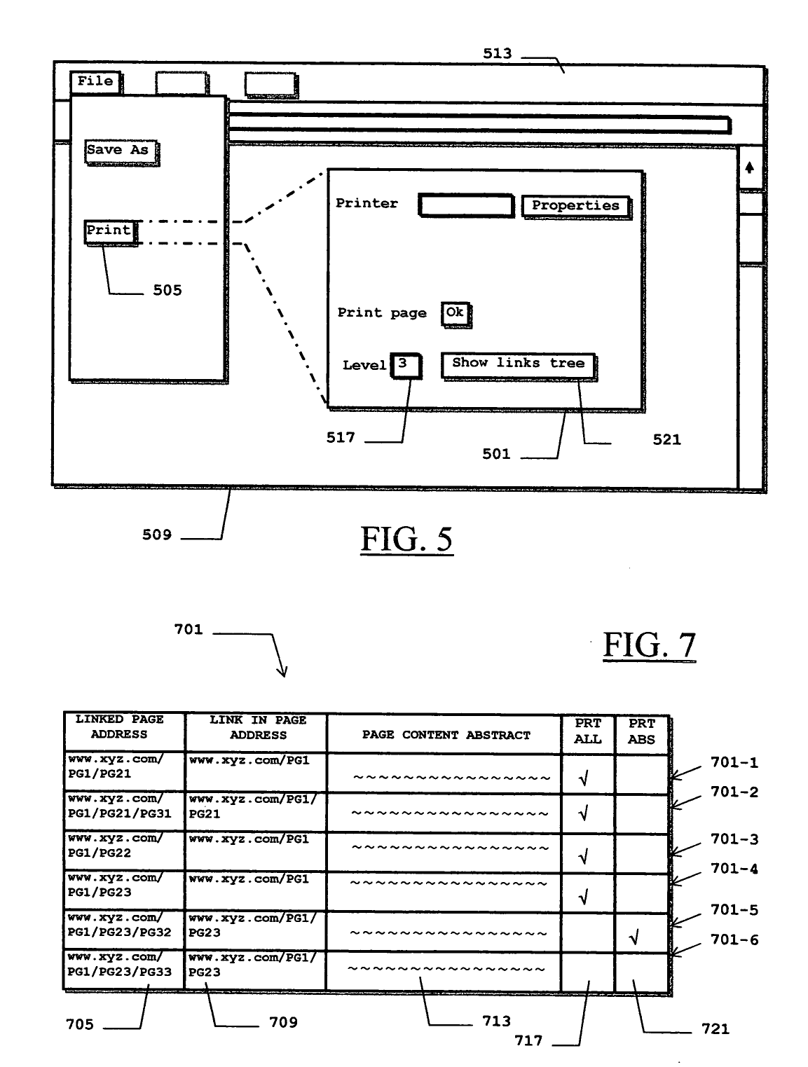

More specifically, referring to FIG. 5, a simplified print menu 501 is schematically depicted; the print menu 501 is for example entered as in conventional Web browsers, by selecting a Print command 505 in a File menu 509 of a menu bar 513 of the window displayed by the Web browser on the display device 211. In addition to conventional operations such as selecting an available printer and setting desired properties thereof, the user is enabled defining a level of depth of an exploration of the group of linked Web pages, that will be automatically conducted by the browsing software starting from the currently-displayed Web page PG1; in particular, the user can enter in an input box 517 a value defining said level of depth; preferably, a predefined or default level of depth can be provided for (e.g., a default level equal to 1).

Clicking on a button 521, the user then instructs the browsing software to build and display a hierarchic tree showing, in an easily readable way for the user, the hyperlink relationship between the currently-displayed Web page PG1 (in the following, simply referred to as the main Web page) and any Web page directly linked thereto (in the following, referred to as first-level linked Web sub-pages), such as the Web pages PG21, PG22 and PG23, and, similarly, the hyperlink relationship between each of the first-level Web sub-pages and second-level Web sub-pages directly linked thereto, if any, and so on, down to a Web sub-page level corresponding to the level of depth selected by the user, or to the default level of depth. For example, assuming that the user selects a level of depth equal to three, the hierarchic tree that will be built and displayed to the user will show the hyperlink relationship between the main Web page PG1 and the first-level Web sub-pages PG21, PG22 and PG23; the hyperlink relationship between the first-level Web sub-page PG21 and the second-level Web sub-page PG31, between the first-level Web sub-page PG23 and the second-level Web sub-pages PG32 and PG33, and between the first-level Web sub-page PG32 and the second-level Web sub-pages PG41.

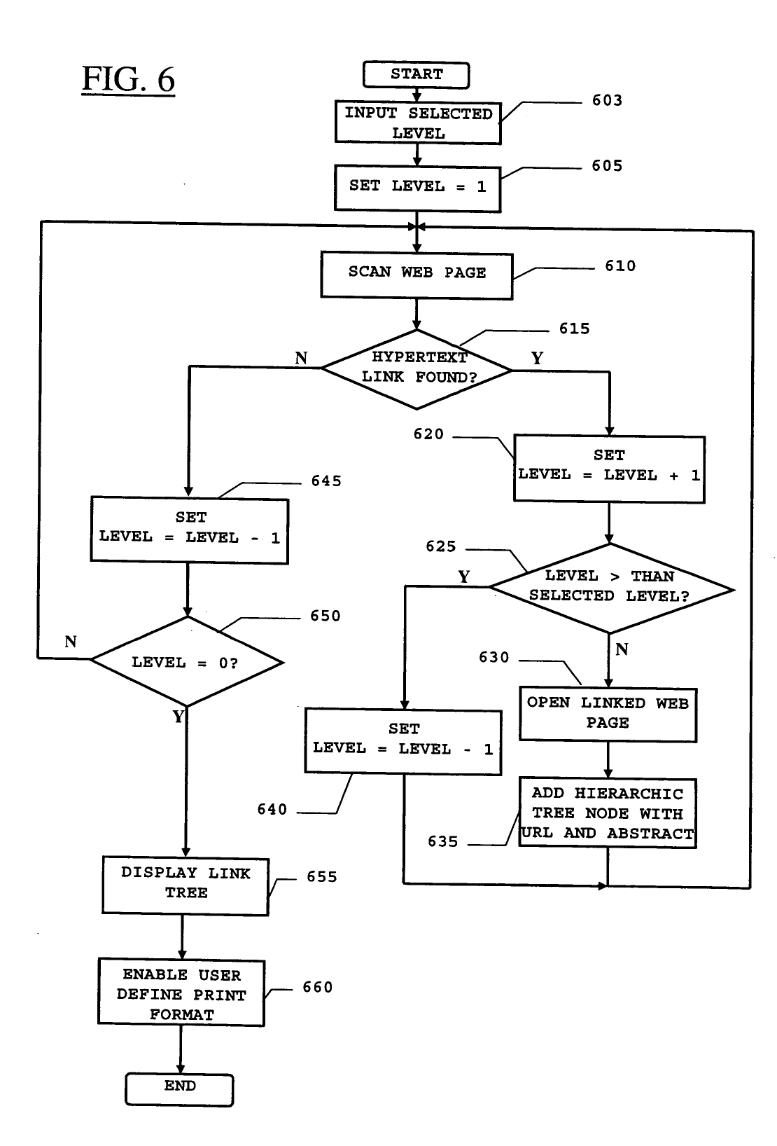

To this purpose, as shown in FIG. 3, in an embodiment of the present invention, the browsing software includes a Web page analyzer software module 325 and a hierarchic tree builder software module 329. The simplified flowchart of FIG. 6 schematically shows the operation of the Web page analyzer 325 and the hierarchic tree builder 329, according to an embodiment of the present invention. The Web page analyzer 325 is, for example, invoked when the user clicks on the button 521 of the menu 501, thereby launching the procedure for building up and displaying the hierarchic tree representation of the group of linked Web pages. When the Web page analyzer 325 is invoked, the GUI 301 passes thereto as an input parameter the user-specified value defining the selected level of depth or the default level of depth (block 603). The Web page analyzer 325 exploits a software variable LEVEL 351, which is initially set at a starting value, equal to one (block 605); the variable LEVEL 351 is used for controlling the number of iterations of the operations performed by the Web page analyzer 325.

The Web page analyzer 325 scans the currently-displayed Web page, for example the Web page PG1, searching for any hypertext link included therein (block 610). A hypertext link is recognizable because it is typically defined by a specific tag, particularly, in HTML, the tag <a>. In the example herein considered, the three hypertext links LNK1, LNK2 and LNK3 embedded in the main Web page PG1 are thus respectively defined by:

<a href=_{C}www.xyz.com/PG1/PG21 _{C}></a>

<a href=_{C}www.xyz.com/PG1/PG22 _{C}></a>

<a href=_{C}www.xyz.com/PG1/PG21 _{C}></a>

where the value of the variable href defines the address of the linked Web page PG21, PG22, PG23. Thus, in order to find out the hypertext links, the Web page analyzer module 325 scans the currently-displayed Web page PG1 searching for every tag <a> included therein.

During the scan of the currently-displayed Web page, whenever a hypertext link is encountered (decision block 615, exit branch Y), the Web page analyzer 325 increases the value of the variable LEVEL 351 by one unit (block 620); then, the Web page analyzer 325 verifies whether the current value of the variable LEVEL 351 corresponds to the selected level of search depth, selected by the user, or to the default level of depth (decision block 625). In the negative case (decision block 625, exit branch N), the Web page identified by the encountered hypertext link is accessed (block 630): the Web page analyzer module 325 gets the address of the linked Web page, corresponding to the value href associated with the encountered hypertext link, and passes such address to the Web page locator 305, which accesses and downloads the linked Web page. When the Web page has been downloaded, the Web page analyzer 325 adds a new node to the hierarchic tree under construction, analyses the most recently downloaded Web page and creates an abstract thereof (block 635).

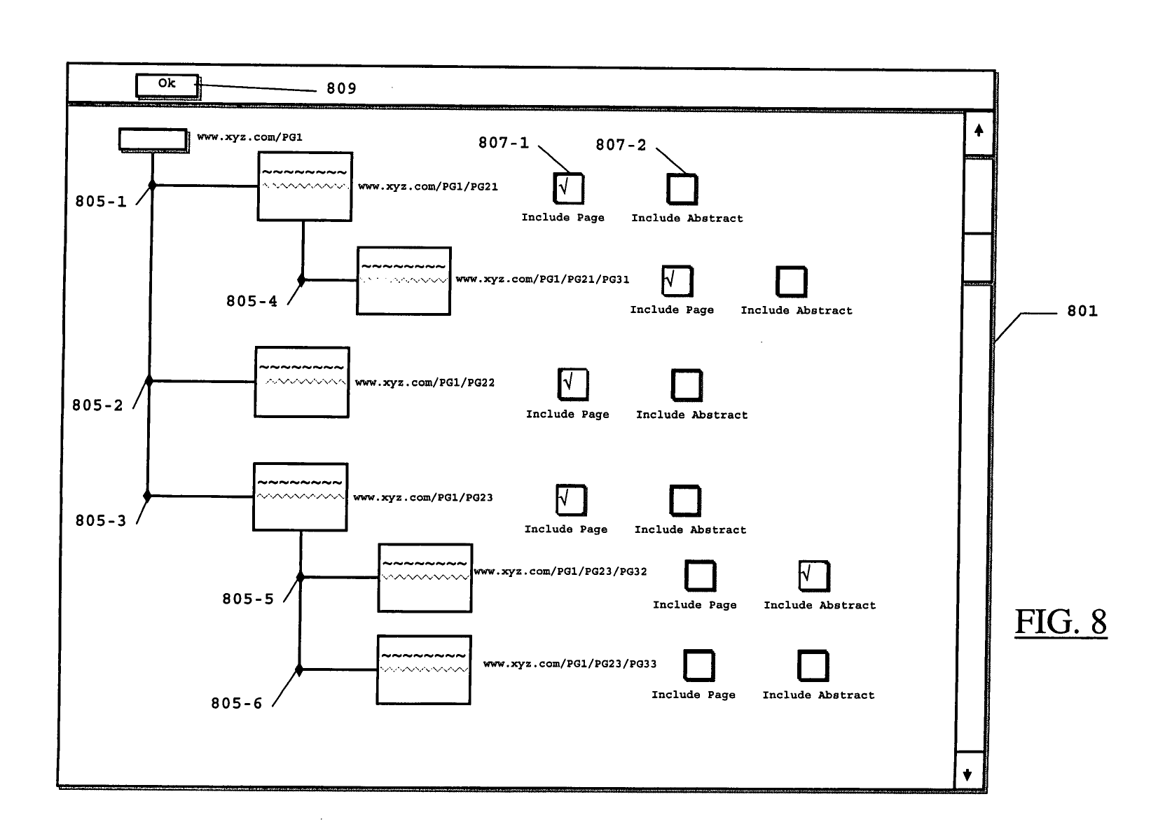

By way of example, the Web page analyzer module 325 progressively builds a table representative of the group of linked Web pages; FIG. 7 schematically shows an exemplary table 701 built by the Web page analyzer 325. During the operation of the Web page analyzer 325, whenever a new Web page has been downloaded into the cache memory area 319 of the computer 105, a new entry is created in the table 701. A generic entry of the table 701 contains a plurality of fields 705, 709, 713, 717, 721 and 725. The field 705 is intended to store the address of the corresponding linked Web page; the field 709 stores the address of the upper-level Web page including the hypertext link to the corresponding linked Web page; the field 713 is intended to store an abstract of the corresponding Web page; the fields 717 and 721 are intended to be used as flags to be set depending on a selection by the user, as will be described later on.

In order to create the abstract of the most recently downloaded Web page (present in the cache area 319), the Web page analyzer 325 may for example scan the Web page and take the first few lines of text in the body thereof, or, alternatively, the content of head portion. The abstract of the Web page thus created is put in the field 713 of the table 701. The length (in terms of words or characters) of the abstract may be fixed or it can be a user-defined parameter that, similarly to the level of depth, the user can input through the menu 501. Clearly, the longer the abstract, the more information will be conveyed to the user.

After the new entry in the table 701 has been created, the operation flow jumps back to the block 610, and the operations described above are repeated on the newly downloaded Web page; in particular, the newly downloaded Web page is scanned, so as to determine whether it contains hypertext links, just like the starting Web page PG1.

If, on the contrary, the Web page analyzer 325 ascertains that the selected level of depth has already been reached (decision block 625, exit branch Y), the linked Web page identified by the most recently encountered hypertext link is not accessed, and the value of the variable LEVEL 351 is decreased by one unit (block 640). The operation flow then jumps back to block 610: the Web page analyzer 320 goes on scanning the Web page that was being scanned before encountering the previous hypertext link; if additional hypertext links are identified in the Web page, the corresponding Web pages will not be accessed.

When no more links are found in the Web page being scanned (decision block 615, exit branch N), the value of the variable LEVEL is decreased by one unit (block 645).

Then, it is ascertained whether the value of the variable LEVEL is equal to zero (decision block 650): in the negative case (decision block 650, exit branch N), the operation flow jumps back to block 610, and the scan of the current Web page continues; in the affirmative case (decision block 650, exit branch Y), the operation of analysis of the initial Web page is considered completed.

For example, let it be assumed that the starting Web page is the exemplary page PG1 of FIG. 4, and that the user has selected a value equal to three for the level of depth of the exploration. While scanning the Web page PG1, the Web page analyzer 325 first encounters the hypertext link LNK1 to the first-level Web sub-page PG21; the Web sub-page PG21 is thus accessed, and a new entry 701-1 is added to the table 700, with an abstract of the Web sub-page PG21; then, the Web page PG21 is scanned, and the hypertext link LNK4 to the second-level Web sub-page PG31 is first discovered: the Web sub-page PG31 is thus accessed, and a new entry 701-2 is added to the table 700, with an abstract of the Web sub-page PG31. The Web sub-page PG31 is scanned, but no hypertext links are found. The scan of the Web sub-page PG21 is then resumed, but no other links in addition to the already found link LNK4 are found; the Web page analyzer 325 jumps back to the initial Web page PG1. The scan of the Web page PG1 is continued, and the hypertext link LNK2 to the first-level Web sub-page PG22 is encountered; the Web sub-page PG22 is accessed, a new entry 701-3 is added to the table 701 tree, and an abstract of the Web sub-page PG22 is added; the scan of the Web sub-page PG22 reveals that no links are present therein, so that the Web page analyzer 320 returns to the starting Web page PG1. The last hypertext link LNK3 to the first-level Web sub-page PG23 is then encountered. The Web sub-page PG23 is thus accessed, and a new entry 701-4 is added to the table 701, with an abstract of the Web sub-page PG23. The Web sub-page PG23 is then scanned, and the hypertext link LNK5 to the second-level Web sub-page PG32 is found; the Web sub-page PG32 is accessed, a new entry 701-5 is added to the table 701, with an abstract of the Web sub-page PG32. The Web sub-page PG32 is scanned, and the hypertext link LNK7 to the third-level Web sub-page PG41 is encountered; however, since the Web sub-page PG41 is at a deeper level than the selected level of depth of the exploration, the Web sub-page PG41 is not accessed; since the Web sub-page PG32 contains no more links, the Web page analyzer 320 jumps back to the Web sub-page PG23; the hypertext link LNK6 to the second-level Web sub-page PG33 is thus encountered; this Web sub-page is accessed, a new entry 701-6 is added to the table 701, and an abstract of this page is added. Since no more hypertext links are encountered, neither in the Web sub-page PG33, nor in the Web sub-page PG23, nor in the starting Web page PG1, the process of building of the hyperlinks hierarchic tree is completed.

It is observed that in this way, if a given Web page includes two or more times a same hypertext link, the linked page would be included two or more times in the table 701. Alternatively, and preferably, it is possible to condition the inclusion of a hypertext link in the table 701 to the absence of such a link (same values in the fields 705 and 709) in the table itself.

It is also observed that the Web page analyzer module 325 may exploit a stack into which the Web page currently analyzed, or at least an associated scan pointer used for scanning the Web page currently analyzed, are temporarily stored whenever a hypertext link is encountered and the linked Web page is to be accessed and scanned. In this way, the analysis of the Web page can be resumed from the point where the hypertext link has been encountered. Alternatively, the Web page currently analyzed can be scanned thoroughly, and every hypertext link found therein stored in a stack or in a FIFO queue; after completion of the Web page scan, each one of the hypertext links will then be taken from the stack or from the FIFO queue, and the linked Web pages will thus be accessed (on condition that the selected level of depth has not yet been reached) and analyzed.

Then, the Web page analyzer 325 invokes the hierarchic tree builder module 329. On the basis of the table 701 built by the Web page analyzer 325 in the previous phases, the hierarchic tree builder 329 builds a new HTML page, which is displayed to the user in substitution of the initial Web page PG1 (block 655), for allowing him/her defining (block 660) a print format for the group of linked Web pages including the starting Web page and the pages linked thereto, either directly or indirectly. In particular, the hierarchic tree builder module 329 causes a menu page to be displayed by the GUI 301 to the user, containing a tree-like representation of the hyperlink relationship between the starting Web page and the Web pages linked thereto, both directly and indirectly.

FIG. 8 pictorially shows an exemplary menu page 801, created by the hierarchic tree builder 329, with reference to the exemplary group of Web pages of FIG. 4. Each hyperlink, i.e. each Web page linked to the main Web page PG1, either directly or indirectly, having a corresponding entry in the table 701, is represented as a node in the tree-like diagram. Referring to the above example, three nodes 805-1, 805-2 and 805-3 at the root level (the level of the main Web page PG1) correspond to the three first-level Web sub-pages PG21, PG22 and PG23, linked directly to the main Web page PG1; a node 805-4 at the level of the first-level Web sub-page PG21 corresponds to the second-level Web sub-page PG31, while two nodes 805-5 and 805-6 at the level of the first-level Web sub-page PG23 correspond to the second-level Web sub-pages PG32 and PG33, respectively. For each node, the hierarchic tree builder 329 takes, from the table 701, the address of the respective linked Web page stored in the field 705, and the abstract thereof, stored in the field 713; the address and the abstract of the linked Web page corresponding to each node in the tree-like diagram are displayed aside the node symbol.

Additionally, for each node in the tree-like diagram two selection elements 807-1, 807-2 are provided, for example two check boxes, which the user can activate: a first check box 807-1, if activated, will cause the whole Web page (text and graphics) corresponding to that node to be printed in-line with the text of the Web page that included the link thereto; a second check box 807-2, if activated, will cause only the abstract of the Web page corresponding to that node to be printed in-line with the Web page that included the link thereto. Simultaneous selection of the two check boxes is forbidden, or one selection (e.g., the one determining the inclusion of the whole Web page) takes priority over the other. If neither one of the check boxes is activated, the corresponding Web page will not be printed.

The user is thus enabled to define the Web page printout format, by defining, for each Web page corresponding to a node in tree-like diagram, whether such Web page is to be printed in its entirety, or abstract only, or if such a Web page is not to be printed at all.

The selection made by the user is stored in the table 701; in particular, if a generic Web page, corresponding to a node in the tree-like diagram, and thus having a corresponding entry in the table 701, has been selected for being printed in its entirety (text and graphics) (check box 807-1 selected), the flag 717 in the table entry corresponding to that Web page is set; if instead the user decided that only the abstract of that Web page shall be printed (check box 807-2 selected), the flag 721 is set; none of the flags 717 and 721 is set if the corresponding Web page has not been selected for printing by the user.

In the shown example, the Web pages PG21, PG22, PG23 and PG31 are assumed to have been selected for being printed in their entirety, the Web page PG32 is assumed to have been selected for being printed abstract only, and the Web page PG32 is assumed not to have been selected for printing. Thus, referring to FIG. 7, the flags 717 of the table entries 701-1, 701-2, 701-3 and 701-4 are set, the flag 721 of the table entry 701-5 is set, while no flags are set for the table entry 701-6.

When the user has completed the process of defining the Web page printing options (for example, he/she may do so by clicking an _{C}Ok_{C} button 809 in the window 801), an output document builder software module 333 of the browsing software is invoked by the hierarchic tree builder 329. The output document builder 333 creates an output electronic document containing all the information to be printed by the printer (or to be saved as a file on the hard disk), according to the user's selections, and causes the output document to printed (onto paper or to an electronic file).

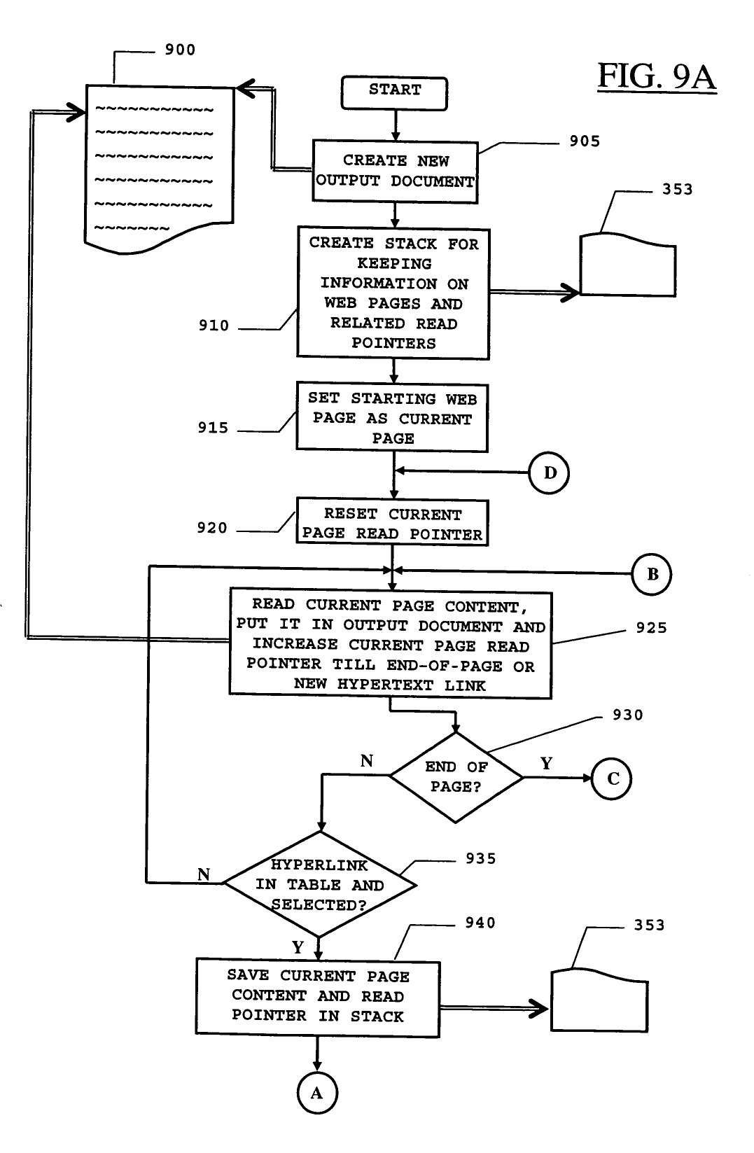

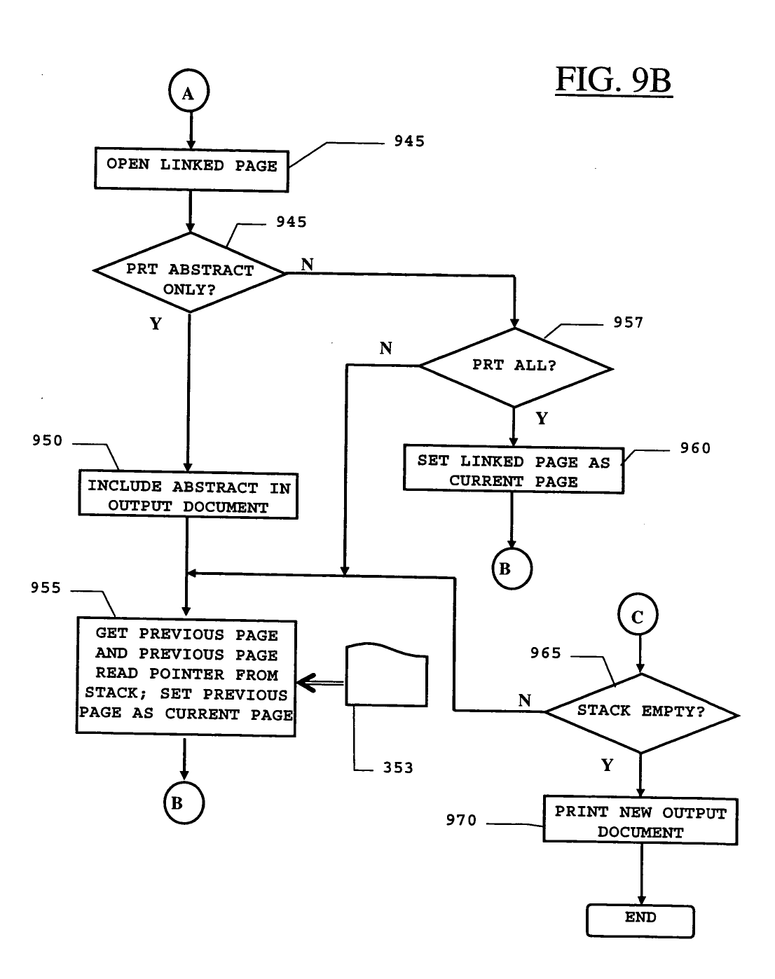

FIGS. 9A and 9B show a simplified flowchart schematically illustrating the operation of the output document builder 333. For the sake of simplicity, the operation of the output document builder 333 will be herein below described making reference to the example considered in the foregoing of the group of pages depicted in FIG. 4.

First of all, a new output document 900 is created and opened (block 905).

Similarly to the Web page analyzer 325, the output document builder 333 will scan the Web pages in search of hypertext links, and, dependent on the user selection, for copying the information content thereof into the output document 900. A stack 353 is created in the working memory 207 of the computer 105 (block 910); the stack 353 will be used by the output document builder 333 for temporarily saving the information content of the Web pages to be printed, as well as respective read pointer values defining the points of the Web pages reached during the respective scan; the read pointer value may for example be expressed in terms of number of words or characters from the beginning of the corresponding Web page.

The main or starting Web page PG1 is then set as the current page under analysis by the output document builder 333 (block 915); the associated read pointer value is reset (block 920).

The output document builder 333 starts reading the current Web page PG1 and copying it into the output document 900, increasing the read pointer (block 925); it is observed that since the current Web page is the starting page PG1, it is not necessary for the Web browsing software to open it, since it is already open. In the context of the present description, reading the current Web page is to be intended widely, meaning that the information content (text, graphics, format information such as fonts, colors and the like) of the current Web page is read. This operation continues till the end of the current Web page is reached (decision block 930), or a new hypertext link embedded in the current Web page PG1 is encountered. In this latter case (decision block 930, exit branch N), the output document builder 333 accesses the table 701 previously created by the hierarchic tree builder 329, and checks whether the encountered hypertext link is present therein; the output document builder 333 can determine that the encountered link is in the table by searching for the Web page address corresponding to the encountered hypertext link (value of href) in the field 705 of each table entry 701-1 to 701-6, and, if the address is found, verifying that the Web page address stored in the corresponding field 709 coincides with the address of the current Web page. If the hypertext link is present in the table 701, the output document builder 333 verifies whether the flag 717 or the flag 721 is set (decision block 935).

If the hypertext link is not found in the table 701, or it is found but neither one nor the other of the flags 717 and 721 is set (decision block 935, exit branch N), the information content of the linked Web page is not to be included in the output document 900. The operation flow jumps back to the block 925, and the output document builder 333 goes on copying the information content of the current Web page into the output document 900 until the next hypertext link or the end of the Web page.

If instead the hypertext link is found in the table 701, and one of the two flags 717, 721 is set (decision block 935, exit branch Y), the output document builder 333 saves the current Web page content and the respective read pointer value into the stack 353 (block 940). Then (block 945) the output document builder 333 opens the Web sub-page linked to by the encountered link (block 945); it is observed that in order to get the Web sub-page linked to by the encountered link, it is in general sufficient for the output document builder 333 to access the cache memory area 319, where a copy of the Web pages previously downloaded is present; however, in an alternative embodiment of the invention, the output document builder 333 may access the linked Web sub-page through the Web page locator and downloader 305.

The output document builder 333 then inspects the flag 721 of the entry in the table 701 that corresponds to the Web sub-page just opened, thereby determining whether, according to the selection made by the user, only the abstract of this Web sub-page is to be included in the output document 900 (decision block 945); in the affirmative case (decision block 945, exit branch Y), the abstract of the Web sub-page, taken from the field 713 of the corresponding entry of the table 701, is included in the output file 900 (block 950). The Web page that was being analyzed before opening the current Web sub-page is then loaded from the stack 353 and opened again, together with the respective read pointer (block 955), and this Web page is reasserted as current page. The operation flow jumps back to block 925.

If the flag 721 is not set, the output document builder 333 ascertains whether the flag 717 is set (decision block 957). If the flag 717 is not set either, meaning that neither the abstract, nor the whole Web sub-page are to be included in the output document (decision block 957, exit branch N), the operation flow jumps to block 955: the Web page previously being scanned is taken from the stack 353, together with the respective read pointer value, for resuming the analysis thereof. If instead the whole Web sub-page is to be included in the output document 900 (exit branch Y of decision block 957), the output document builder 333 sets the most recently accessed Web sub-page as the current Web page (block 960), and the operation flow jumps back to block 925; the same operations as on the main page are thus carried out on the current Web sub-page. The Web sub-page is read and the information content thereof is incorporated in the output file 900 at a position corresponding to the point in which the associated hypertext link was present in the main Web page.

Referring back to block 930, when the end of the current page is reached (decision block 930, exit branch Y), the output document builder 333 checks whether the stack 353 is empty (decision block 960). In the negative case (decision block 960, exit branch N), the operation flow jumps to block 955: the previous Web page (in the hyperlink hierarchy) is taken from the stack 353, together with the respective read pointer value, and the Web page taken from the stack 353 is set as the current page, for resuming the analysis thereof. Differently, if the stack 353 is empty (decision block 360, exit branch Y), the preparation of the output document 900 is considered completed, and the output document ready for printing 337 is sent to the printer for being printed; alternatively, the output document ready to be saved 341 is saved on the hard disk (depending on a selection by the user).

In the example herein considered, the output document builder 333 starts scanning the main Web page PG1 and copying the information content thereof into the newly created output document 900. The first the hypertext link LNK1 to the first-level Web sub-page PG21 is then encountered; this link is present in the table 701, and since the corresponding flag 717 (print all) is set, the main Web page PG1 and the associated read pointer value are put in the stack 353, and the Web sub-page PG21 is accessed. The output document builder 333 starts scanning the Web sub-page PG21, copying the information content thereof into the output document 900 at a location corresponding to that in which the hypertext link thereto was found. The hypertext link LNK4 to the second-level Web sub-page PG31 is then found; also this link is present in the table 701, and since the corresponding flag 717 is set, also the first-level Web sub-page PG21 and the associated read pointer value are put in the stack 353, and the second-level Web sub-page PG31 is accessed. The output document builder 333 starts scanning the Web sub-page PG31, copying the information content thereof into the output document 900 at a location corresponding to that in which the hypertext link thereto was found. The scan of the Web sub-page PG31 goes on till the end of the page without encountering further hypertext links. The Web sub-page PG21 is then taken from the stack 353, and the scan thereof is resumed; since no further hypertext links are found in the Web sub-page PG21, the end of the Web sub-page PG21 is reached, the main Web page PG1 and the associated read pointer value are taken from the stack 353, for resuming the scan of this page. The hypertext link LNK2 to the first-level Web sub-page PG22 is then encountered: this link is found in the table 701, and the corresponding flag 717 is set; the main Web page PG1 and the associated read pointer value are again saved in the stack 353, and the Web sub-page PG22 is accessed; the output document builder 333 starts scanning the Web sub-page PG22, copying the information content thereof into the output document 900 at a location corresponding to that in which the hypertext link thereto was found. The Web sub-page PG22 contains no hypertext links, so that once the end of the Web sub-page PG22 is reached, the main Web page PG1 and the associated read pointer are taken from the stack and the scan thereof is resumed. The hypertext link LNK3 to the first-level Web sub-page PG23 is finally encountered. Also this link is present in the table 701, and the corresponding flag 717 is set: the main Web page PG1 and the associated read pointer value are once again put in the stack 353; the Web sub-page PG23 is accessed, and its content is included in the output document. While scanning the Web sub-page PG23, the hypertext link LNK5 to the second-level Web sub-page PG32 is found; this links is found in the table 701, and the corresponding flag 723 is set, thereby only the abstract (got from the table 701) is included in the output document at a location corresponding to that in which the hypertext link was present. The Web sub-page PG23 and the associated read pointer value are then taken from the stack 353, and the scan of this Web sub-page is resumed. The hypertrext link to the second-level Web sub-page PG33 is eventually found; this link is found in the table 701, and the Web sub-page PG33 is thus accessed after having saved in the stack 353 the Web sub-page PG23 and the associated read pointer value. Since neither the flag 717 nor the flag 723 are set, the content of the Web sub-page PG33 is not to be included in the output document 900; the Web sub-page PG23 and the associated read pointer value are taken from the stack 353 and the scan of the Web sub-page PG23 is resumed. No more hypertext links are found in the Web sub-page PG23, nor in the main Web page PG1, when the scan thereof is resumed. The preparation of the output document is considered completed, and the output document is printed (to paper or to a file).

Thanks to the present invention, the operation of printing Web pages including hyperlinks to other Web pages is made much more easier for the user, and the results are much better. In particular, the advantages of the present invention are best appreciated in presence of nested hyperlinks.

In particular, the user can easily appreciate the information content of Web sub-pages directly or indirectly linked to a starting Web page, without having to manually visit each of those pages. The user is then allowed selecting, for each Web sub-page, whether a relatively short abstract of that sub-page, or all the sub-page (or nothing) is to be included into the output document to be printed. The inclusion is made at a point that corresponds to the position of the respective hyperlink. An organic, easily readable output document is thus created.

In an alternative to the described embodiment, the user may be offered the additionally possibility of selecting with a single action to include in the output document all the Web sub-pages in the hierarchic tree that are linked, directly or indirectly, to the main Web page (i.e., to include all the Web pages in the hierarchic tree), or to include all the Web sub-pages that are directly or indirectly linked to any given Web sub-page in the hierarchic tree (i.e., to include all the Web pages in one or more sub-trees of the hierarchic tree), without necessitating the user to individually select each of the Web sub-pages. For example, these possibilities can be associated by default with the inclusion in the output document of the abstract of each Web sub-page, or of the whole Web sub-page information content.

In the foregoing description it has been assumed that, in the build-up phase of the hierarchic tree representation of the group of linked Web pages (FIG. 6), any type of hypertext link encountered in the main Web page or in a Web sub-page is considered, irrespective of the fact that the linked hypertext document resides on the same Web server as the main Web page (internal link) or on a different Web site (external link). It can be appreciated that the risk of entering an infinite loop in case of nested links is not incurred thanks to the provision of the iteration limit set by the predefined level of depth. In an alternative embodiment of the invention, only the hypertext links to Web sub-pages resident on the same Web server as the main Web page are considered, and the respective linked Web sub-pages are accessed and analyzed. It is observed that a hypertext link can be recognized to be an external or an internal link depending on the hypertext document address specified in the link; in particular, internal links have a portion of address in common with the main Web page. In still another alternative, the choice between considering any kind of hypertext link or only hypertext links to Web sub-pages resident on the same Web server is left to the user, in a way similar to the selection of the level of depth of the exploration to be conducted.

The present invention can be implemented in a relatively simple way by developing specifically-designed software plug-ins for the most common Web browsers; such plug-ins can be developed in any programming language, such as Java or C++.

It is pointed that although described in connection with Web pages, the present invention can be applied in general to electronic documents embedding links to other electronic documents.

1. In a data processing apparatus (105) executing a hypertext-document browsing software application, a method of managing requests to print a selected hypertext electronic document comprising:
a) creating an output electronic document and incorporating therein an information content of the selected hypertext electronic document; and
b) automatically inspecting the selected hypertext electronic document for detecting hypertext links included therein, each hypertext link linking a respective linked hypertext electronic document to the selected hypertext electronic document;
further comprising, for each hypertext link detected in the selected hypertext electronic document:
c) automatically accessing the respective linked hypertext document;
d) extracting from the linked hypertext document an indication of an information content thereof;
e) providing the user with said indication of the information content of the linked hypertext electronic document;
f) conditioned by a selection of the user, including at least said indication of the information content of the linked hypertext electronic document into the output electronic document.

2. The method according to claim 1, in which act f) comprises including at least said indication of the information content of the linked hypertext electronic document at a position within the output electronic document corresponding to a position of the respective hypertext link in the selected hypertext electronic document.

3. The method according to claim 1 in which act f) further comprises, for each hypertext link enabling the user to chose (i) not to include, (ii) to include only said indication of the information content or (iii) to include the full information content of the respective linked hypertext document.

4. The method according to claim 1 further comprising:
iterating the acts b) to f) on each linked hypertext electronic document, until a predefined level of iteration is reached.

5. The method according to claim 4, further comprising:
enabling the user defining said level of iteration.

6. The method according to claim 1 in which said acts e) and f) include:
generating a tree-like diagram of the linked hypertext electronic documents, said tree-like diagram including a tree node for each linked hypertext electronic document;
displaying to the user the tree-like diagram, associated with each tree node the indication of the information content of the respective linked hypertext electronic document, and
enabling the user to define, for each tree node, whether or not at least the indication of the information content of the respective linked hypertext document is to be included in the output electronic document.

7. The method claim 1, further including sending the output electronic document to a printer for printing onto a material support, or storing the output electronic document on a storage device.

8. A computer program directly loadable into a memory of a data processing apparatus, for actuating the method according to any one of the preceding claims when the program is executed.

9. A computer program product comprising a computer readable medium on which the computer program of claim 8 is stored.

10. A hypertext-document browsing software application, comprising:
means for locating and accessing selected hypertext electronic documents according to respective addresses; and
means for managing requests of printing of the selected hypertext electronic documents, characterized in that
said means for managing print requests includes;
means for automatically inspecting a selected hypertext electronic document to be printed for detecting hypertext links, each hypertext link linking a respective linked hypertext electronic document to the selected hypertext electronic document;
means for automatically accessing the hypertext documents corresponding to the detected hypertext links, without having the user personally activating the corresponding hypertext link;
means for providing the user with an indication of an information content of each of the linked hypertext electronic documents, and for enabling the user defining whether or not the linked document is to be printed, and
means for creating an output electronic document containing an information content of the selected hypertext electronic document and, conditioned by a selection made by the user, at least said indication of the information content of the respective linked hypertext electronic document.

11. A data processing system supporting the exchange of hypertext electronic documents, comprising at least one computer programmed to execute the hypertext document browsing software application of claim 8.
